(19) United States
(12) Patent Application Publication
(10) Pub. No.: US 2013/0321687 A1
(43) Pub. Date: Dec. 5, 2013

(54) LIGHT METERING IN CAMERAS FOR BACKLIT SCENES

(71) Applicants: Dimitri Negroponte, Los Angeles, CA (US); Clinton B. Hope, Los Angeles, CA (US)

(72) Inventors: Dimitri Negroponte, Los Angeles, CA (US); Clinton B. Hope, Los Angeles, CA (US)

(21) Appl. No.: 13/992,654

(22) PCT Filed: Dec. 9, 2010
(86) PCT No.: PCT/US10/59695

§ 371 Date: Aug. 13, 2013

(51) Int. Cl. H04N 5/235; H04N 5/232

(52) U.S. Cl. CPC H04N 5/2351; H04N 5/23293
USPC 348/333.11

(57) ABSTRACT

In various embodiments, a camera may use novel techniques to calculate proper exposure for a backlit scene, or a scene that otherwise has very high contrast ratios between different parts of the scene. In one embodiment, a touchscreen is used as a viewfinder, and the user may touch the viewfinder to indicate that part of the scene where proper exposure is desired. In another embodiment, a rear-facing exposure meter may use the light levels from the photographer to set the exposure levels for the front facing camera.

### BACKGROUND

Most cameras come with automatic exposure control to assure that the correct amount of light reaches the light sensors for each picture taken, even though the scenes being photographed may have widely different light levels. Through a combination of exposure time (controlling how long the sensors are exposed to the light from the scene) and aperture size (controlling how much of the light from the scene is prevented from reaching the sensors), a wide range of light levels may be accommodated. Once the exposure setting is determined, the entire scene may be sensed using that setting. However, some scenes have a wide range of light intensity in different parts of the same scene, for example ranging from bright sunlight to deep shadow, which can result in both over- and under-exposure for different parts of the scene. The problem is especially noticeable for backlit scenes, in which a bright light source (such as the sun) is facing the camera and illuminating much of the scene, but the main object of the photograph (such as the face of a person) is in shadow. Various metering techniques have been developed to give more importance to certain areas of the scene in the hope that the object of the photograph will be in that area, but this is an imperfect approach, frequently based on incorrect assumptions about which parts of the scene are important.

### BRIEF DESCRIPTION OF THE DRAWINGS

Some embodiments of the invention may be better understood by referring to the following description and accompanying drawings that are used to illustrate embodiments of the invention. In the drawings:

FIGS. 1A, 1B show a handheld digital camera device, according to an embodiment of the invention.

FIG. 2 shows an image depicted on a display used as a viewfinder, according to an embodiment of the invention.

FIG. 3 shows a flow diagram of a method of determining exposure setting for taking a picture of a scene with high contrast ratios, according to an embodiment of the invention.

FIG. 4 shows a flow diagram of a method for determining exposure setting for a front-facing camera by sensing light in a rearward direction, according to an embodiment of the invention.

FIG. 5 shows a flow diagram of a method of using a diffuser on a rear-facing light sensor, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible non-transitory storage medium, such as but not limited to read only memory (ROM); random access memory (RAM); magnetic disk storage media; optical storage media; a flash memory device, etc.

Various embodiments of the invention pertain to a light metering system for a camera, that improves the exposure setting for scenes that have a wide range of light intensity in different parts of the scene. It should be especially useful for backlit scenes in the sunlight, which typically have the highest contrast. In some embodiments, the user may be able to select which part of the scene is to be used for calibrating exposure, by touching that part of the scene on a touchscreen viewfinder. In other embodiments a separate light meter facing away from the subject may be used, to avoid the directly incoming bright light and instead use reflected light as the calibration reference. In either case, the scene depicted on the viewfinder may be adjusted to show the effect of that particular metering technique.

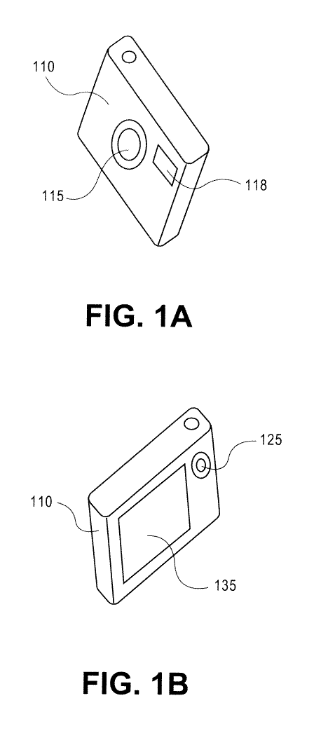

FIGS. 1A, 1B show a handheld digital camera device, according to an embodiment of the invention. Device 110 may be primarily a camera, or may be primarily another type of device that contains the functionality of a camera. In either case, only the camera-related features are shown in FIGS. 1A, 1B, and device 110 may be referred to herein as a camera regardless of what other capabilities it has. Device 110 may be capable of taking still photographs, video, or both, and all these versions may be referred to herein as a camera.

FIG. 1A shows the front side of the camera 110 (the side facing the scene to be photographed), with a lens 115. In various embodiments, lens 115 may have a fixed focal length or a variable focal length (e.g., for zoom effects), may have a fixed physical position or a variable position (e.g., for extending the lens while in use or retracting it for compact storage when not in use), and/or may have a protective lens cover for preventing damage to the lens when not in use. Various other features may be included as well, such as but not limited to a flash unit 118 for illuminating the scene to be photographed, and/or a second lens (not shown) which can be used in addition to or instead of the lens 115.

FIG. 1B shows the back side of the camera (typically the side facing the photographer, or user). From this angle, it can be seen that camera 110 has a display 135 which may be used as a viewfinder. In some embodiments, display 135 may be a touchscreen, so that it may display the view seen through the lens, and may also be used as an input device that senses when and where the user touches it. Some embodiments may also have a secondary lens 125 on the back side of the camera. This may be used for various purposes, as described later. Camera 110 may also have an internal light sensor (not shown) to sense the light coming through lens 115, the light sensor to be used to form the image shown on display 135. In some embodiments, the light sensor may be used to sense light from both lenses, and be able to create images from the light from both lenses. In some embodiments each lens may have a separate light sensor, to independently form the separate images.

Camera 110 may also have an internal exposure control system (not shown), which takes the sensed light levels and calculates the correct exposure setting for taking the picture, based on the sensed light levels. Although the camera 110 is shown with a particular shape, and with particular features located in particular places, this is for example only. Other embodiments may have any feasible shape, and the various features may be located in any feasible places, as long as the desired functionality is maintained.

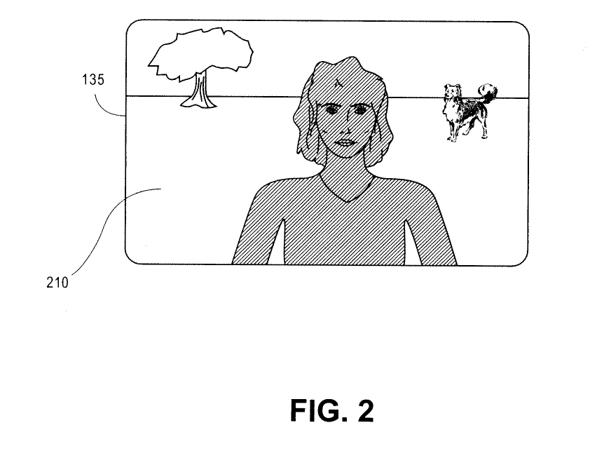

FIG. 2 shows an image depicted on a display used as a viewfinder, according to an embodiment of the invention. On display 135, the illustrated image 210 is meant to depict a backlit scene, in which the intended object of the scene is a person whose visible portion is in shadow, while much of the surrounding scene is brightly lit. Such backlit scenes may occur in various situations, most commonly when the surrounding areas is receiving direct sunlight, while the object is either in shade or the visible portion of the object is in its own shadow due to the position of the sun. In such situations, most automated exposure systems will select a particular area of the display and adjust the exposure setting for the entire image to properly expose that particular area. The remaining areas are allowed to have an improper exposure setting. However, if the intended object of the scene is not in that area, or is only partially in that area, then the intended object may be improperly exposed. Various approaches to determine the proper exposure setting for the object of the scene are described below.

### Touchscreen Interaction by User

Referring again to FIG. 2, touchscreen 135 may be displaying scene 210, which is the image that will be photographed if the user takes the picture. In some embodiments, the user may touch the portion of the screen displaying the object that the user wants to be properly exposed when the picture is taken. For example, the user may touch the person's face in the image, and the camera may adjust the exposure so that the person's face will be properly exposed, regardless of where on the touchscreen that face appears.

Since a touch by a fingertip will make contact with the touchscreen over an area, rather than at a point, the area of contact is referred to here as a touchprint. The area of the touchscreen that is to be used for calculating the exposure is referred to here as the exposure area.

Although the exposure area may be indicated by the touchprint, the exposure area may or may not be the same as the area of the touchprint. The exposure area may be determined in various ways, such as but not limited to:

1) The exposure area may be a single point or very small area (for example, a few pixels) within the touchprint. In some embodiments it may be located at or near the center of the touchprint.

2) The exposure area may be a subset of the touchprint, with a defined size. For example, it may be one-half or one-fourth the size of the touchprint.

3) The exposure area may be the same as the touchprint.

4) The exposure area may have a defined size larger than the touchprint, so that the touchprint is a subset of the exposure area.

In some embodiments the size of the exposure area may be programmable, either automatically or by the user.

The pixels within the exposure area that are to be used in calculating the exposure setting may be selected in various ways, such as but not limited to:

1) All the pixels in the exposure area may be selected for the calculation.

2) A pattern of selected pixels from across the exposure area may be selected (for example, every third pixel in both the horizontal and vertical directions, or a starburst pattern with a higher concentration of pixels near the center of the pattern).

In some embodiments the selection of pixels may be programmable, either automatically or by the user.

A relative weight may be assigned to each pixel for calculating exposure. As used here, ‘weight’ indicates the relative importance given to the intensity value of the light for that pixel, and is generally handled by multiplying the light intensity value by the weight to derive a final value for the pixel to be used in the calculation. The weight assigned to each selected pixel when calculating exposure may be chosen in various ways, such as but not limited to:

1) All the selected pixels may have the same weight.

2) Selected pixels near the center of the exposure area may be given more weight than pixels near the outer edges of the exposure area, resulting in a center-weighted exposure algorithm.

3) The contrast between pixels in the exposure area may affect the weight given to each selected pixel. For example, pixels in the exposure area that are much brighter than other pixels in the exposure area (i.e., have light levels that are greater than the other pixels by a predetermined minimum amount), may be assumed to be in the brighter backlit area of the scene, rather than part of the object of the picture, and therefore given little weight or zero weight (zero weight is equivalent to ignoring those pixels).

In some embodiments the pixel weighting scheme may be programmable, either automatically or by the user.

Various other techniques may be used to determine which pixels will be selected, and how much weight to give those selected pixels, in determining the exposure setting.

It is possible that movement of the camera may cause the camera's direction to change, and the scene shown on the touchscreen to therefore shift, between the time the user inputs a touchprint and the time the picture is taken. If the pixels are selected and the relative brightness of those pixels are recorded before the scene shifts, this may make no difference in the calculated exposure, as long as the intended object of the picture is still in the scene when the picture is taken. This may actually provide a benefit, since the user may set the exposure and then compose the scene in the viewfinder before taking the picture.

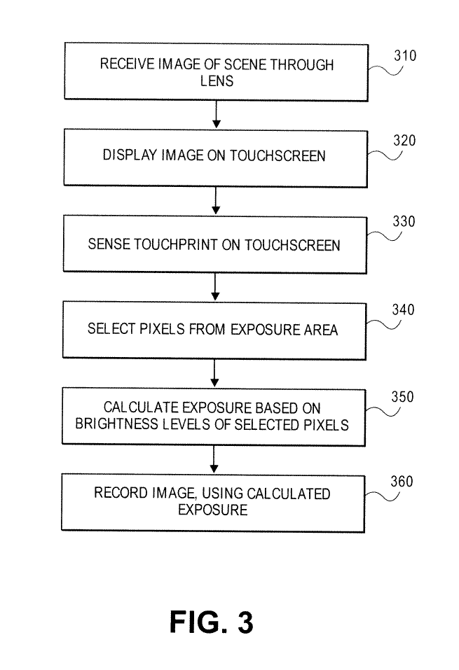

FIG. 3 shows a flow diagram of a method of determining exposure for taking a picture of a scene with high contrast ratios, according to an embodiment of the invention. At 310, a camera may receive the light from a scene to be photographed, pass the light through a lens, and sense the image of that scene with a light sensor. At 320 the image of the scene may be displayed on a touchscreen that acts as a viewfinder for the camera.

When the user is ready to determine the correct exposure setting for a specific part of the image, the user may touch that part of the touchscreen which is displaying that part of the image, and that touch may be sensed by the camera at 330. Although a direct touch area is one embodiment, other embodiments may use other touch inputs, such as but not limited to tracing a ring around the intended exposure area, and using the interior of that ring as the exposure area. To avoid false triggers, the camera may require another input to be initiated before, or simultaneously with, the touch, so that the camera will know that this touch is intended to be used for calculating exposure. Any feasible input may be used for this purpose, such as but not limited to depressing a button to signal that an exposure-setting touch is intended.

Once the touch has been identified as a notice to calculate exposure, the correct pixels for the exposure area may be determined at 340. This determination may be performed as previously described, or in any other feasible manner. At 350, the exposure setting may be determined, based on the brightness levels associated with the selected pixels. In some embodiments, the determination may include a weighting factor for each of the selected pixels. Various algorithms may be used in the calculation, and are not further described here.

Once the exposure is determined, the picture may be taken at 360 by adjusting the exposure to the correct level and storing the image received by the light sensor. In some embodiments the picture, as taken with the selected exposure, may be presented on the touchscreen so the user can accept or reject the picture as taken with that exposure. Although it is anticipated that the scene depicted on the touchscreen will frequently be the scene that is photographed, in some instances the exposure setting may be determined with one scene, and that setting used to photograph a partially or completely different scene.

### Rear-Facing Exposure Meter

In some embodiments, measuring the light reflected from the face or body of the photographer may be used to calculate the exposure. In those situations, it may be assumed that the face of the user and the visible portion of the object of the picture are both illuminated by the same intensity of light rather than by the light that illuminates most of the scene's background. For example, such situations may occur if:

1) The user's face or body and the intended object's visible portion are both in the shade, while the background in the scene is brightly lit. This might occur, for example, if both are in the shade of a tree.

2) The user and the intended object are both indoors, but there is a window behind the intended object with bright light seen through the window.

3) It is dark in the surrounding area, with artificial light illuminating both the user and the intended object.

FIG. 1B shows a rear-facing lens 125 that may be used to measure the light level reflected from the user. Lens 125 may take various forms, such as but not limited to: 1) a light sensor, 2) another camera lens, which can be used to take pictures of objects behind the camera. The same light sensor used for the rear facing camera may be used in this instance to measure rearward light levels when the front-facing camera is being used to take a picture. In some embodiments, the front-facing camera and the rear-facing camera may share some components, such as the image sensor. In such a case, the light sensor may sense light from the two lenses at different times, to prevent the light from one lens from causing errors when sensing light from the other lens. Various techniques may be used to permit a single light sensor to be used by two lenses facing in different directions. The rear facing camera may also have various other uses which are not described here to avoid confusing those uses with the embodiments described here.

If the rear-facing lens 125 is part of a rear facing camera, the image detected by the rear facing camera may be analyzed to aid in sensing the correct exposure for the front-facing camera taking a backlit picture. For example, the face of the user may be distinguished from the remaining image sensed by the rear-facing camera, and the light intensity measured for that face may be used to determine exposure control for the front facing camera. In another example, if high contrast levels are detected by the rear-racing camera, the lower light levels may be used for exposure control, under the assumption that the high light levels are due to the same bright light that illuminates the background for the front facing camera. Other techniques may also be used.

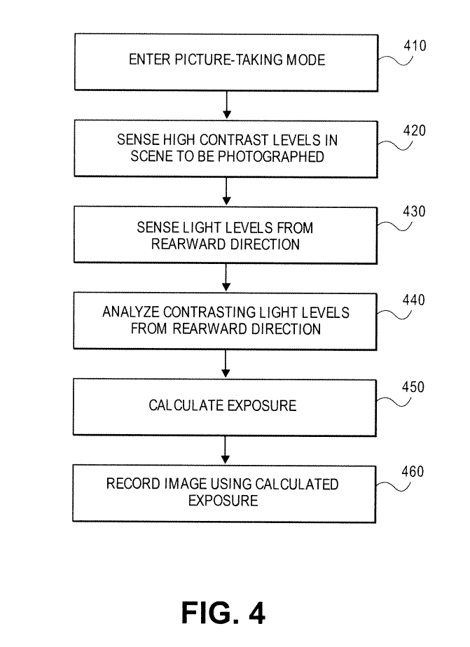

FIG. 4 shows a flow diagram of a method for determining exposure setting for a front-facing camera by sensing light in a rearward direction, according to an embodiment of the invention. At 410, the camera may enter a picture-taking mode, thereby triggering the following operations. While detecting the image of the scene with the image sensor, high contrast levels may be determined at 420, which may trigger a non-standard process for calculating the exposure level. In some embodiments, high contrast in different parts of the scene may be detected automatically by the camera. In other embodiments, the user may make that decision based on what is visible in the viewfinder, or by simply making an informed judgment about lighting conditions in the scene.

Once the decision to use a rear-facing light sensor has been made, that rear-facing sensor may be used at 430. If the rear-facing sensor is also a camera, and the system has enough intelligence to analyze the image detected by that camera, it may perform that analysis at 440. For example, the system may distinguish between the close up image of the user and the background image behind the photographer, and use the light levels from the photographer as the reference for exposure control.

At 450, the exposure setting for the picture to be taken by the front-facing camera may be calculated. The picture may then be taken and recorded at 460, using the calculated exposure level. As before, in some embodiments the picture, as taken with the selected exposure, may be presented on the touchscreen so the user can accept or reject the picture as taken with that exposure.

### Movable Diffuser for Rear-Facing Light Meter

When the rear-facing lens 125 is used to measure light levels for the front-facing camera, a selectable diffuser may be placed over the lens 125 so that the light sensor may receive light from a broader range of directions. This may have the effect of ‘smoothing out’ the various intensities of light reaching the sensor from the user's face, and user's upper body, and the area behind the user. In some embodiments, the diffuser may be retractable and permanently connected to the camera, so that it covers the lens only when selected for use, but remains with the camera at all times. In other embodiments the diffuser may be permanently in place over the lens. In still other embodiments, the diffuser may be attachable and removable by the user.

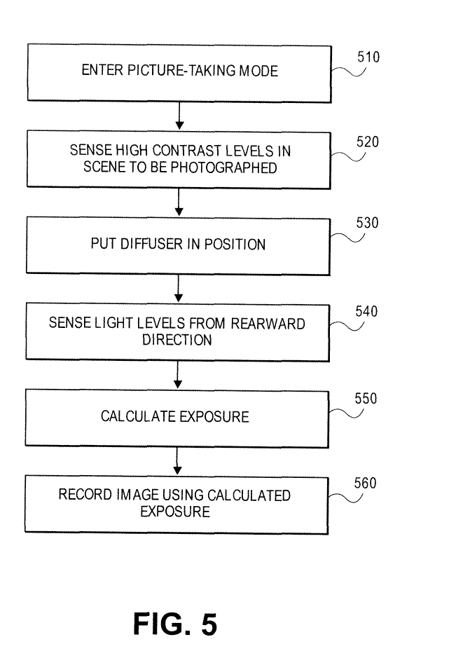

FIG. 5 shows a flow diagram of a method of using a diffuser on a rear-facing light sensor, according to an embodiment of the invention. At 510, the camera may enter a picture-taking mode, thereby triggering the following operations. While inputting the image of the scene that is to be photographed, high contrast levels may be determined at 520, which may trigger a non-standard process for calculating the exposure level. In some embodiments, high contrast in different parts of the scene may be detected automatically by the camera. In other embodiments, the user may make that decision based on what is visible in the viewfinder, or by simply making an informed judgment about lighting conditions in the scene.

Once the decision to use a rear-facing light sensor has been made, a movable diffuser may be moved at 530 into position over the rear-facing light sensor so that the sensor will receive diffused light. At 540, that diffused light may be sensed. This may have the effect of smoothing out light from multiple directions, so that an average light level is sensed.

At 550, the exposure setting for the picture to be taken by the front-facing camera may be calculated, based on the diffused light sensed at 540. The picture may then be taken and recorded at 560, using the calculated exposure level. As before, in some embodiments the picture, as taken with the selected exposure, may be presented on the touchscreen so the user can accept or reject the picture as taken with that exposure.

The foregoing description is intended to be illustrative and not limiting. Variations will occur to those of skill in the art. Those variations are intended to be included in the various embodiments of the invention, which are limited only by the scope of the following claims.

1. A camera comprising:
a lens for receiving light from a scene to be recorded;
a light sensor coupled to the lens for receiving the light from the lens;
a touchscreen coupled to the light sensor for displaying an image of the scene; and
an exposure control system coupled to the light sensor and the lens for controlling light levels reaching the light sensor;
wherein the exposure control system is to calculate an exposure setting for the scene based on light levels from an exposure area of the scene, the exposure area indicated by sensing a touchprint on the touchscreen where at least a part of the exposure area is displayed.

2. The camera of claim 1, wherein the exposure control system is to use all pixels in the exposure area to calculate the exposure.

3. The camera of claim 1, wherein the exposure control system is to use selected pixels in the exposure area to calculate the exposure.

4. The camera of claim 1, wherein the exposure control system is to include some pixels from an area surrounding the touchprint to calculate the exposure.

5. The camera of claim 1, wherein the exposure control system is to assign different weights to different ones of pixels used in calculating the exposure.

6. The camera of claim 5 wherein the exposure control system is to reduce a weight of certain pixels when calculating the exposure, based on the certain pixels in the exposure area having a light intensity greater than other pixels in the exposure area by at least a predetermined amount.

7. The camera of claim 1, wherein the camera is to receive a signal indicating the touchprint is to be used to calculate the exposure setting.

8. A method, comprising:
receiving light from a scene to be photographed through a lens;
displaying an image of the scene on a touchscreen;
sensing a touchprint on the touchscreen;
calculating an exposure setting for an exposure area indicated by the touchprint; and
recording the image, using the calculated exposure setting.

9. The method of claim 8, wherein said calculating uses all pixels in the exposure area to calculate the exposure.

10. The method of claim 8, wherein said calculating uses a subset of pixels in the touchprint to calculate the exposure.

11. The method of claim 8, wherein said calculating uses some pixels from an area surrounding the touchprint to calculate the exposure.

12. The method of claim 8, wherein said calculating assigns different weights to different ones of pixels used in calculating the exposure.

13. The method of claim 12 wherein said calculating reduces a weight of certain pixels based on the certain pixels in the touchprint having a light intensity greater than other pixels in the touchprint by at least a predetermined amount.

14. The method of claim 8, further comprising receiving a signal indicating the touchprint is to be used to calculate the exposure setting.

15. An article comprising
a computer-readable non-transitory storage medium that contains instructions, which when executed by one or more processors result in performing operations comprising:
receiving light from a scene to be photographed through a lens;
displaying an image of the scene on a touchscreen;
sensing a touchprint on the touchscreen;
calculating an exposure setting for a part of the image indicated by the touchprint; and
recording the image, using the calculated exposure.

16. The article of claim 15, wherein the operation of calculating uses all pixels in the touchprint to calculate the exposure.

17. The article of claim 15, wherein the operation of calculating uses a subset of pixels in the touchprint to calculate the exposure.

18. The article of claim 15, wherein the operation of calculating uses some pixels from an area surrounding the touchprint to calculate the exposure.

19. The article of claim 15, wherein the operation of calculating assigns different weights to different ones of pixels used in calculating the exposure.

20. The article of claim 19, wherein the operation of calculating reduces a weight of certain pixels based on the certain pixels in the touchprint having a light intensity greater than other pixels in the touchprint by at least a predetermined amount.

21. The article of claim 15, wherein the operations further comprise receiving a signal indicating the touchprint is to be used to calculate the exposure setting.

22-43. (canceled)
